(19) United States
(12) Patent Application Publication
(10) Pub. No.: US 2006/0032387 A1
(43) Pub. Date: Feb. 16, 2006

(54) Flexographic ink printing machine

(75) Inventors: Hiromi Watanabe, Aichi (JP); Nokihisa Adachi, Aichi (JP)

Correspondence Address: STROOCK & STROOCK & LAVAN LLP, 180 MAIDEN LANE, NEW YORK, NY, 10038, US

(73) Assignee: Kabushiki Kaisha Isowa

(21) Appl. No.: 11/197,932

(22) Filed: Aug. 5, 2005

(30) Foreign Application Priority Data
Aug. 10, 2004 (JP) 2004-233629

(51) Int. Cl. B41F 31/02; B41F 31/08

(52) U.S. Cl. 101/366; 101/367

(57) ABSTRACT

A flexographic ink printing machine is provided in which ink is circulated in order to prevent solidifying of the ink during a printing operation, whereby during ink supplying or ink recovering operations, high efficiency of supplying and recovering the ink can be obtained. A printing machine which includes an ink reservoir, an ink supply source, and ink delivery tubings each connecting said ink reservoir to said ink supply source, whereby the ink supplied from said ink supply source via at least one of said ink delivery tubings to said ink reservoir and accumulated therein is used for printing, said ink delivery tubings including ink recovery tubings for recovering the flexographic ink from said ink reservoir to said ink supply source, said ink recovery tubings having their ink recovery opening ends located within said ink reservoir, said ink delivery tubings including ink supply tubing for supplying the flexographic ink from said ink supply source to said ink reservoir, said ink supply tubing having its ink supply opening end located within said ink reservoir, whereby the ink within said ink reservoir is maintained in a dynamic state by supplying said flexographic ink from said ink supply source to said ink reservoir via said ink supply tubing and by recovering the flexographic ink from said ink reservoir to said ink supply source via said ink recovery tubings during the printing operation of the printing machine, wherein: said ink recovery tubings and said ink supply tubing have ink transfer means which can transfer the ink in both forward and backward directions between said ink supply source and said ink reservoir, wherein the flexographic ink is recovered from said ink reservoir to said ink supply source via said ink recovery tubings and said ink supply tubing now being used as an ink recovery tubing during ink recovering, and wherein the flexographic ink is supplied from said ink supply source to said ink reservoir via said ink supply tubing and said ink recovery tubings now being used as ink supply tubings during ink supplying.

### FIELD OF THE INVENTION

The present invention relates to a printing machine using flexographic ink, more particularly, to a flexographic ink printing machine in which solidifying of the ink can be prevented during a printing operation, whereby during ink supplying or during ink recovering, highly efficient supplying and recovering of the ink can be obtained.

### BACKGROUND OF THE INVENTION

Conventionally, when a printing machine prints a sheet of paper, such as a corrugated board with flexographic ink, it is common to press a printing die having ink applied thereon against the surface of a sheet. These printing machines, such as disclosed in Japanese patent document S55-45,568(U) and S60-119,539(U), usually include a pair of rollers, one of which supports the printing die on the outer surface thereof, an ink reservoir formed between said roller and another roller engaging therewith, an ink supply source, and a ink supply tubing and ink recovery tubings each connected between the ink reservoir and the ink supply source to provide fluid communication therebetween, such that the ink supplied from the ink supply source to the ink reservoir via the ink supply tubing and accumulated in the ink reservoir is transferred to the printing die and used for printing.

More particularly, during the printing operation, the ink within the ink reservoir is maintained in a dynamic state or circulated state by supplying the flexographic ink from the ink supply source to the ink reservoir via the ink supply tubing and by recovering the flexographic ink from the ink reservoir to the ink supply source via the ink recovery tubings, which allows the proper printing operation of the printing machine using the flexographic ink.

Such flexographic ink printing machines can be categorized in two types, in terms of ink circulation routes.

The first type, such as disclosed in the above mentioned S55-45, 568, for example, utilizes an ink pan disposed below the respective ends of the pair of rolls. In accordance with this type of printing machine, the circulation route of the ink during the printing operation is formed by the ink pan, the ink recovery tubings, the ink supply source, the ink supply tubing and the ink reservoir through an end portion of the ink reservoir.

The second type, such as disclosed in the above mentioned S60-119,539, for example, utilizes a pair of dam members disposed at the respective ends of a pair of rolls. In accordance with this type of printing machine, the circulation route of the ink during the printing operation is formed by the ink recovery tubings, the ink supply source, the ink supply tubing and the ink reservoir through the liquid surface of the ink reservoir.

However, there are several technical problems in such printing machines, especially during ink supplying for preparing the printing operation and during ink recovering after the printing operation has been completed.

The first problem is that, on the one hand, during ink supplying, ink is supplied from the ink supply source to the ink reservoir only using the ink supply tubing, during which the transferring operation of the ink recovery tubings is halted, in spite of there existing both the ink supply tubing and the ink recovery tubings for circulating the ink during the printing operation of the printing machine. On the other hand, during ink recovering, ink is recovered from the ink reservoir to the ink supply source only using the ink recovery tubings, during which the transferring operation of the ink supply tubing is halted, in spite of there existing both the ink supply tubing and the ink recovery tubings for circulating the ink during the printing operation of the printing machine.

Therefore, according to the flexographic ink printing machine known in the art, which provides a proper printing operation by preventing the solidifying of the ink, it was difficult to obtain highly efficient supplying and recovering of the ink both during ink supplying for preparing the printing operation and during ink recovering after the printing operation has been completed.

The second problem is that, especially in the second type of the printing machine having a pair of dam members, it was difficult to completely recover the ink remaining in the ink reservoir, because the level of the ink in the ink reservoir drops down gradually during ink recovering, and because the ink reservoir has a cross section narrowly tapering toward its bottom. As a result, it had been necessary to locate the tips of the ink recovery tubings at the bottom of the ink reservoir for recovering the ink. This problem also arises when side surfaces of the pair of the rollers are being rinsed out by using rinsing water after the ink has been recovered.

The third problem is that, a recent trend in the art requires small lots of production, so the printing color must be quickly changed. As a result, the printing machine of the second type mentioned above having a pair of dam members is preferred more than the first type having the ink pan. More particularly, as to the lengths of the circulating routes of the ink in both types of the printing machine, the second type has a shorter circulating route especially for the ink delivery tubings due to the fact that it does not have a ink pan, than the first type. Thus higher efficiency in supplying and recovering of the ink and/or rinsing water can be obtained in the second type. Therefore, there exists a need to remodel the existing printing machine of the first type, which involves removing the ink pan and attaching a pair of dam members, thereby changing the ink circulating route in the printing machine.

However, if an existing flexographic ink printing machine of the first type is remodeled by attaching new ink transfer tubings near to the ink reservoir independently of the pair of dam members, the opening end or flow-in end of the ink transfer tubings has to be located at or near the bottom of the ink reservoir in order to allow complete recovering of the ink during ink recovering, whereby much time is needed for supporting and fixing operations for the ink transfer tubings. Thus it is difficult to remodel such a printing machine efficiently.

One object of the present invention is to provide a flexographic ink printing machine in which ink is circulated in order to prevent solidifying of the ink during the printing operation, whereby during the ink supplying or during ink recovering, high efficiency in supplying and recovering of the ink can be obtained.

Another object of the present invention is to provide a flexographic ink printing machine which can be obtained through an efficient remodeling of an existing printing machine of the type having an ink pan.

Another object of the present invention is to provide a flexographic ink printing machine having a pair of dam members, in which high efficiency in recovering of the ink can be obtained.

### SUMMARY OF THE INVENTION

In accordance with one aspect of the present invention, there is provided a printing machine which comprises:
an ink reservoir, an ink supply source, and one or more ink delivery tubings each connecting said ink reservoir to said ink supply source, whereby the ink supplied from said ink supply source via at least one of said ink delivery tubings to said ink reservoir and accumulated therein is used for printing, said ink delivery tubings including ink recovery tubings for recovering the flexographic ink from said ink reservoir to said ink supply source, said ink recovery tubings having their ink recovery opening ends located within said ink reservoir, said ink delivery tubings including an ink supply tubing for supplying the flexographic ink from said ink supply source to said ink reservoir, said ink supply tubing having its ink supply opening end located within said ink reservoir, whereby the ink within said ink reservoir is maintained in a dynamic state by supplying said flexographic ink from said ink supply source to said ink reservoir via said ink supply tubing and by recovering the flexographic ink from said ink reservoir to said ink supply source via said ink recovery tubings during the printing operation of the printing machine, wherein:
said ink recovery tubings and said ink supply tubing have ink transfer means which can transfer the ink in both forward and backward directions between said ink supply source and said ink reservoir,
wherein the flexographic ink is recovered from said ink reservoir to said ink supply source via said ink recovery tubings and said ink supply tubing now being used as an ink recovery tubing during ink recovering, and wherein the flexographic ink is supplied from said ink supply source to said ink reservoir via said ink supply tubing and said ink recovery tubings now being used as ink supply tubings during ink supplying.

According to the printing machine disclosed above, during the printing operation, the ink within the ink reservoir is maintained in a dynamic state or circulated state by supplying the flexographic ink from the ink supply source to the ink reservoir via the ink supply tubing and by recovering the flexographic ink from the ink reservoir to the ink supply source via the ink recovery tubings, which allows the proper printing operation of the printing machine using the flexographic ink.

On the one hand, i.e., during ink supplying, the flowing direction of the ink flowing through the ink transfer means of the ink recovery tubings is reversed with respect to the flowing direction during a normal printing operation, in order to use the ink recovery tubings for supplying the ink from the ink supply source to the ink reservoir along with the ink supply tubing. Thus the efficiency of the ink supplying can be improved simply by changing the transferring direction of the ink transfer means, compared to the case in which only the ink supply tubing is used.

On the other hand, i.e., during ink recovering, the flowing direction of the ink flowing through the ink transfer means of the ink supply tubing is reversed with respect to the flowing direction during a normal printing operation, in order to use the ink supply tubing for recovering the ink from the ink reservoir to the ink supply source along with the ink recovery tubings. Thus the efficiency of the ink recovery can be improved simply by changing the transferring direction of the ink transfer means, compared to the case in which only the ink recovery tubings are used.

One preferred embodiment of the present invention further comprises: said ink reservoir being formed by an inking roller which applies said ink to a printing die, an ink squeezing member extending along the axis of said inking roller in a contacting relationship with the same for the adjustment of the amount of said ink being applied to the printing die, and a pair of dam members disposed at common end extremities of said inking roller and said ink squeezing member;
said pair of dam members having ink flowing paths formed therein, respectively, said respective ink flowing paths having flowing in/out openings located at an inner surface of the said ink reservoir, said ink flowing path being in fluid communication with said ink delivery tubings.

In one preferred embodiment of the present invention further comprising:
a pair of squeezing blades located within said ink reservoir abut against the side surfaces of the said inking roller and said ink squeezing member;
a blade moving mechanism for moving the squeezing blades in said pair of squeezing blades in the opposite axial directions of said inking roller;
a supplement water supply source connected to said ink supply tubing; and
wherein said ink supply opening end is located between said pair of squeezing blades, whereby when the squeezing blades in said pair of squeezing blades are moved in opposite directions toward the respective axial ends of the roller, supplement water from said supplement water supply source is supplied into said ink reservoir through said ink supply opening end in such a manner that the portion of said inking roller locating between said pair of squeezing blades is supplied with water.

According to the printing machine disclosed above, by recovering the ink through the ink recovery tubings while the squeezing blades in the pair of squeezing blades moving toward the axial ends of the inking roller in the axial opposite directions, the ink adhering on the side surfaces of the inking roller and the ink squeezing member can be squeezed out, so that ink is directed into the remaining ink in the ink reservoir formed between squeezing blades and corresponding dam members, which raises the liquid level of the remaining ink in the ink reservoir, whereby allowing complete recovering of the ink.

At this time, water is removed from the ink reservoir in the portion between the pair of squeezing blades, which also causes the removal of the water contained within a number of indentations formed on the inking roller. However, at the same time, supplement water is supplied to the ink reservoir through the ink supply tubing located between the pair of squeezing blades, so as to supplement the water especially in the indentations of the inking roller, whereby allowing a good adhering condition of the ink during the printing operation, and preventing the causing of wear at the rotational contacting portion between the inking roller and the ink squeezing member, thus assuring a long life for the printing machine.

### BRIEF DESCRIPTION OF THE DRAWINGS

The above objects and other objects, features, and advantages of the present invention will now be readily apparent from the following detailed description of the preferred embodiments for carrying out the invention when taken in connection with the accompanying drawings, in which:

FIG. 1 is a perspective view showing a printing machine of the preferred embodiment of the present invention;

FIG. 2 is a side elevational view showing a printing section of the printing machine illustrated in FIG. 1;

FIG. 3 is a piping diagram showing relationships of various tubings and elements of the printing machine illustrated in FIG. 1;

FIG. 4 is a side elevational view showing a pair of squeezing blades of the printing machine illustrated in FIG. 1;

FIGS. 5A and B are a front view and a side view showing dam plates of the printing machine illustrated in FIG. 1;

FIG. 6 is a schematic front view showing a tubing pump; and

FIG. 7 is a schematic side view showing the tubing pump.

### DETAILED DESCRIPTION OF THE PREFERRED EMBODIMENT(S) OF THE INVENTION

The flexographic ink printing machine of the preferred embodiment of the present invention is used for printing corrugated boards with flexographic ink.

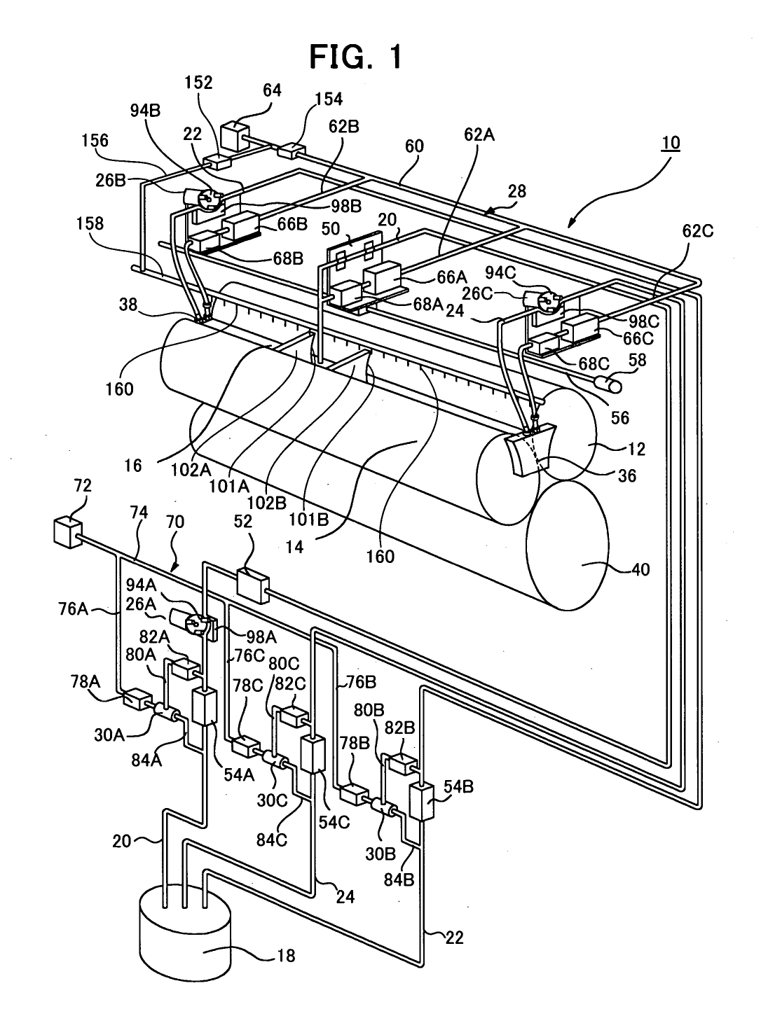

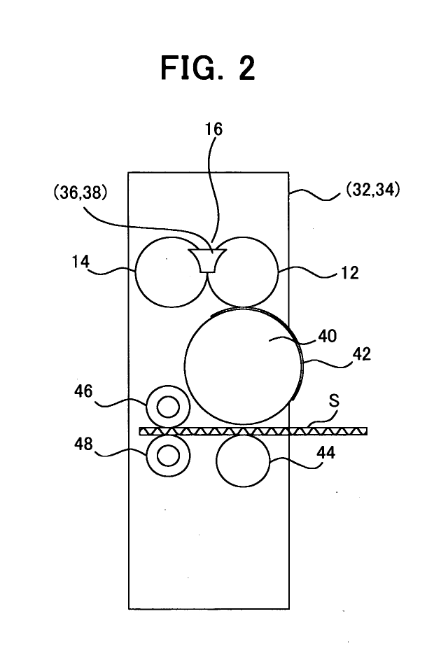

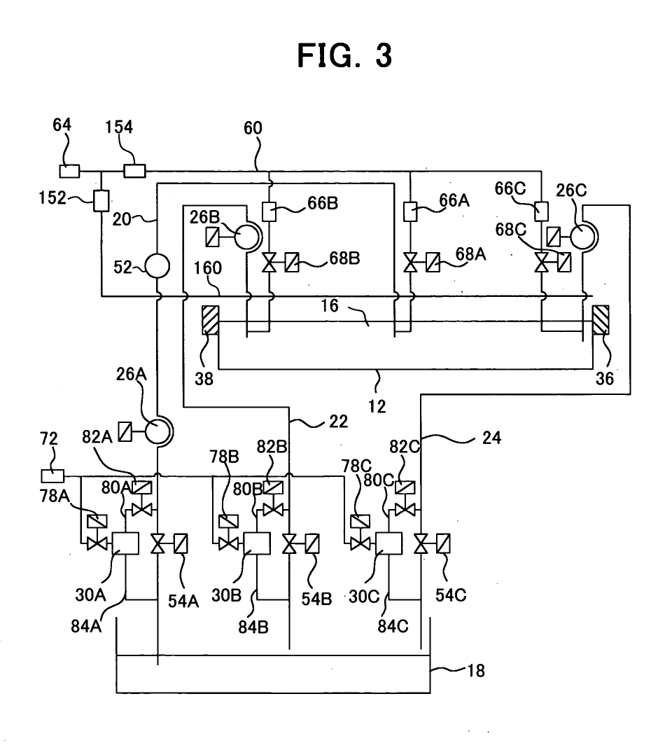

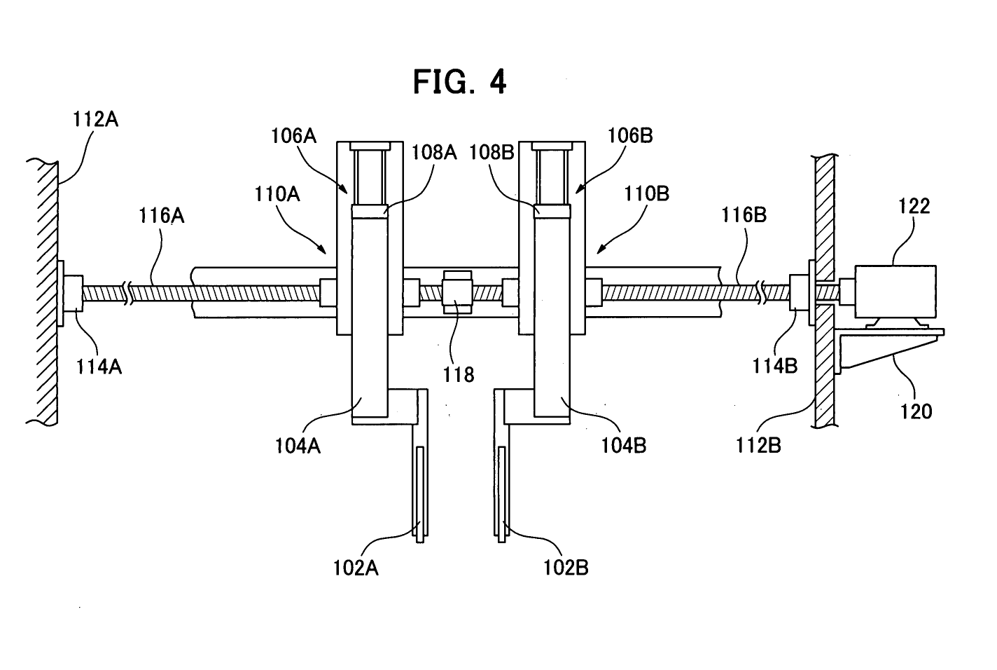

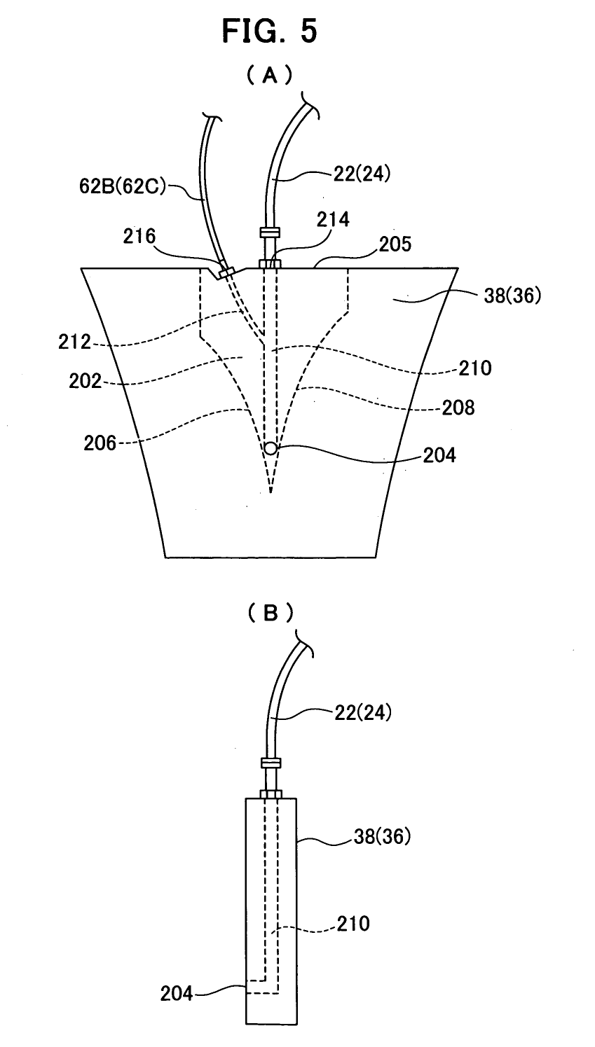

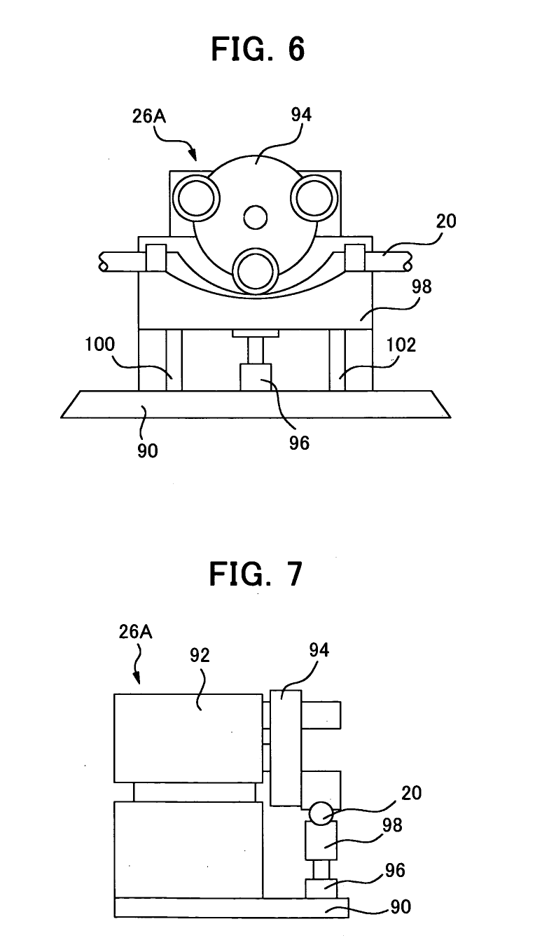

FIG. 1 is a perspective view showing a printing machine of the preferred embodiment of the present invention; FIG. 2 is a side elevational view showing a printing section of the printing machine illustrated in FIG. 1; FIG. 3 is a piping diagram showing relationships of various tubings and elements of the printing machine illustrated in FIG. 1; FIG. 4 is a side elevational view showing a pair of squeezing blades of the printing machine illustrated in FIG. 1; FIGS. 5A and B are a front view and a side view showing dam plates of the printing machine illustrated in FIG. 1; FIG. 6 is a schematic front view showing a tubing pump; and FIG. 7 is a schematic side view showing the tubing pump.

As can be seen in FIG. 1, the printing machine 10 includes an ink reservoir 16 formed by a pair of rollers 12 and 14, an ink supply source 18 disposed underneath the ink reservoir 16, an ink supply tubing 20 and ink recovery tubings 22 and 24 each connected between the ink reservoir 16 and the ink supply source 18 providing fluid communication therebetween, ink transfer pumps 26A, 26B and 26C for transferring ink via the ink supply tubing 20 and the ink recovery tubings 22 and 24, respectively, a water supply tubing 28 for supplying water into the ink supply tubing 20 and the ink recovery tubings 22 and 24, respectively, air ejectors 30A, 30B and 30C each of which generates an air flow in the ink supply tubing 20 and ink recovery tubings 22 and 24, respectively, in order to remove or recover remaining ink in the ink supply tubing 20 and the ink recovery tubings 22 and 24, and a pair of squeezing blades 102A and 102B moveably located within the ink reservoir 16.

As can be seen in FIG. 2, the ink reservoir 16 is formed by an inking roller 12 and an ink squeezing roller 14 which are supported in contact relationship with each other and both of which are supported between a pair of machine frames 32 and 34, and a pair of diaphragms or dam plates 36 and 38 which are supported in a sliding contact relationship with the inking roller 12 and the ink squeezing roller 14 at the common end extremities thereof and which are also supported on the pair of machine frames 32 and 34. The inking roller 12 and the ink squeezing roller 14 are kept in a contact relationship with each other during the printing operation of the printing machine. A printing cylinder 40, disposed under the inking roller 12 and rotatably supported by the pair of machine frames 32 and 34, supports a printing die 42 on the outer surface thereof, whereby the printing die 42 is supported in a contact relationship with the inking roller 12. A corrugated board sheet S is supplied between the printing cylinder 40 and an impression cylinder 44 disposed under the printing cylinder 40 and rotatably supported by the pair of machine frames 32 and 34. When the corrugated board sheet S comes into contact with the printing die 42, flexographic ink applied on the surface of the printing die 42 is transferred or printed onto the sheet S. The corrugated board sheet printed with the flexographic ink will be fed to the next process stage via a pair of feed rollers 46 and 48.

As can be seen in FIG. 1, the ink supply source 18 is a container keeping ink therein and disposed at the lowest part of the printing machine, and one opening end of each of the ink supply tubing 20 and the ink recovery tubings 22 and 24 are positioned inside the ink supply source 18, as described further in detail below. The ink supply source 18 has to be replaced with that filled with another color of ink when printing color is to be changed.

As can be seen in FIG. 1, the one opening end of the ink supply tubing 20 is positioned adjacent to the ink reservoir 16, while the other opening end thereof is positioned adjacent to or inserted in the ink supply source 18. The inner diameter and the length of the ink supply tubing 20 may be chosen depending on various conditions such as the desired flow rate of the ink or distance between the ink supply source 18 and the ink reservoir 16. The ink supply tubing 20 may be, for example, 8 mm in its inner diameter and 5 m in its length, and made of plastic. There is provided in the direction from the ink reservoir 16 to the ink supply source 18 of the ink supply tubing 20 a bracket 50 for supporting the ink supply tubing 20, a viscometer 52 for detecting the viscosity of the flexographic ink in the ink supply tubing 20 which will be explained in more detail below, and a transfer pump 26A and open-close valve 54A both of which will be explained in more detail below. A threaded shaft 56 threadedly engaging with the bracket 50 is rotationally disposed above the ink reservoir 16 along the axes of rollers 12 and 14, and a driving motor 58 is attached at one end of the threaded shaft 56, while the other end thereof (not shown) is supported by the pair of machine frames 32 and 34. The threaded shaft 56 is rotated by the rotation of the driving motor 58, which moves the one of the opening ends of the ink supply tubing 20 along the longitudinal direction of the ink reservoir 16. The level of the one of the opening end may be set in such a manner that it is at least lower than the level of the liquid surface of the ink during the printing operation and lower than the level of the liquid surface of the rinsing water during the rinsing operation, in order to be able to recover the ink and/or the rinsing water being held within the ink reservoir 16. Also, the level of the one of the opening end may be moveably adjusted in the vertical direction so as to be adjusted depending on the surface level of the ink or the rinsing water.

A water supply tubing 28 includes a straight tubing portion 60 disposed above the ink reservoir 16 along the longitudinal direction thereof, and three branch tubing portions 62A, 62B and 62C branched off from the straight tubing portion 60, respectively. The straight tubing portion 60 has a valve 154 located upstream of the branch tubing portion. There are three junction points spaced apart from each other along the longitudinal direction of the ink reservoir 16, i.e., positioned at one end, a middle part and the other end thereof. A water supply source 64 is connected to one opening end of the straight tubing portion 60. An opening end of the branch tubing portion 62A is connected to the ink supply tubing 20 in fluid communication therewith. Each of the opening ends of the branch tubing portions 62B and 62C is connected to the ink recovery tubings 22 and 24, respectively. In the direction from the straight tubing portion 60 to the ink reservoir 16, a water flow meter 66A and an open-close valve 68A are included within the branch tubing portion 62A. The time intervals for feeding water are controlled by the operation of the open-close valve 68A in accordance with the amount of the water flowing through the ink supply tubing 20, which flow rate is detected by the water flow meter 66A.

Furthermore, the water supply tubing 28 is connected to the water delivery tubing 158 via branch tubings 156 having a valve 152. The water delivery tubing 158 is disposed above the ink reservoir 16 in such a manner that it extends in the axial direction of the rollers 12 and 14, and has a plurality of rinsing water jet nozzles 160 located in a spaced apart relationship with respect to each other in the axial direction thereof. Each of the rinsing water jet nozzles 160 are directed downwardly, and by jetting out the rinsing water toward the ink reservoir 16, more particularly, toward the side surface of the inking roller 12, the remaining ink adhering on the side surface can be removed during the printing operation. The spacing or length between adjacent rinsing water jet nozzles 160 may be properly chosen depending upon the amount of the ink which adheres on the rollers 12 and 14. Also, the rinsing water jet nozzles 160 may be moveable in the axial direction thereof. When water is used as the rinsing water, water may be supplied via a plurality of holes provided in the water delivery tubing 158 without using jet nozzles.

A high pressure air supply tubing 70 disposed below the pair of rollers 12 and 14 is connected to a high pressure air source 72 of about 5 kg/cm2 in pressure. The high pressure air tubing 70 includes a straight tubing portion 74 disposed along the longitudinal direction of the ink reservoir 16, and three branch tubing portions 76A, 76B and 76C branched off from the straight tubing portion 74, respectively. The branch tubing portions 76A, 76B and 76C are connected to air ejectors 30A, 30B, and 30C, respectively, fluid communication being provided therebetween by the open-close valves 78A, 78B and 78C. The primary port of the air ejector 30A is connected to the ink supply tubing 20 at a portion thereof which is located slightly apart from the open-close valve 54A toward the ink reservoir 16 via a by-pass tubing 80A including an open-close valve 82A. The secondary port of the air ejector 30A is connected to the ink supply tubing 20 at a portion thereof which is located slightly apart from the open-close valve 54A toward the ink supply source 18 via a by-pass tubing 84A.

The air ejectors 30 known in the art operate as follows. The air ejector 30 includes a diffuser therewithin (not shown) and an expansion chamber (not shown) in fluid communication with the constriction side of the diffuser. The primary compression air supplied via open-close valve 78 and injected into the expansion chamber from a nozzle (not shown) expands and flows into the diffuser at a high flow speed, whereby pressure in the expansion chamber drops. The pressure difference caused thereby is utilized for drawing secondary air out via the open-close valve 82, which is mixed and passed through the diffuser with the primary air, and then flows into the ink supply tubing 20 via the by-pass tubing 84.

Now, the transfer pump 26A will be explained in detail with reference to the FIGS. 6 and 7. The transfer pump is a tubing pump of a known type which transfers flexographic ink in the ink supply tubing 20. A motor 92 is supported upon a base plate 90 having a rotor 94 fixedly attached on the driving shaft thereof, motor 92 applies rotational pressure force against the outer surface of the ink supply tubing 20. A supporting member 98 which supports the ink supply tubing 20 thereon is attached at the top end of the driving rod of an air cylinder 96 which is attached on the base plate 90. The supporting member 98 guided along a pair of guide bars 100 and 102 fixed on the base plate 90 is moved toward or apart from the rotor 94 by driving the air cylinder 96. In order to transfer flexographic ink from the ink supply source 18 to the ink reservoir 16 by using this tubing pump, the supporting member 98 is moved toward the rotor 94 to apply rotational pressure force against the outer surface of the ink supply tubing 20, whereby the flexographic ink is transferred. By changing the rotating direction either forwardly or reversely, the transferring direction of the flexographic ink can be changed either from the ink supply source 18 to the ink reservoir 16 or from the ink reservoir 16 to the ink supply source 18.

In order to release the rotational pressure force applied against the outer surface of the ink supply tubing 20, the supporting member 98 is moved apart from the rotor 94, thereby the ink supply tubing 20 is separated from the rotor. Any other means, besides the air cylinder, such as a threaded shaft may be used for moving the supporting member 98 toward or apart from the rotor 94. Also, the position of the supporting member 98 relative to the rotor 94 can be adjusted for any ink supply tubings 20 with different diameters, whereby rotational pressure force applied on the ink supply tubing can be optimized.

The configuration relating to the ink recovery tubings 22 and 24 are similar to that of the ink supply tubing 20, except that the flow direction of the ink therein is opposite. Thus elements or members the same as those previously disclosed are designated with the same reference numerals, and points of difference between these tubings will only be explained in detail below.

The points of difference which can be seen in FIGS. 1 and 3 are as follows: firstly, the ink supply tubing 20 includes the viscometer 52 whereas the ink recovery tubings 22 and 24 do not include the same; secondly, the ink supply tubing 20 has the tubing pump 26A disposed adjacent to the ink supply source 18, whereas the ink recovery tubings 22 and 24 have the respective tubing pumps 26B and 26C disposed adjacent to the ink reservoir 16; and thirdly, the recovery tubings 22 and 24 are in fluid communication with the pair of dam plates 38 and 36 whereas the ink supply tubing 20 is not in fluid communication therewith.

As regards the first different point mentioned above, although it is advantageous to include the viscometer 52 along the path of the ink supply tubing 20 for detecting the viscosity of the ink being supplied before and/or during the printing operation, the viscometer may be positioned along the path of ink recovery tubings 22 and 24 for detecting the viscosity of the ink being recovered after the printing operation has finished.

The reason for the second different point mentioned above is that, when the ink is transferred by the tubing pump, the resistance due to the flow of the ink can be minimized by placing the tubing pump as near as possible to the ink supply source 18 for the ink supply tubing 20, and as near as possible to the ink reservoir 16 for the ink recovery tubings 22 and 24.

The third different point is that, as can be seen in FIG. 5, the pair of dam plates 38 and 36 have fluid passages 210 formed therein, which have flow in/out openings 204 located at the lower portion of the inner surfaces 202 facing toward the ink reservoir 16. The flow in/out openings 204 are located near the bottom of the ink reservoir 16, i.e., at the lower portion of the inner surfaces 202. The flow in/out openings 204 are preferably located as close as possible to the bottom of the ink reservoir 16 in order to completely recover the ink and/or rinsing water remaining in the ink reservoir 16. The inner fluid passages 210 are divided into two ways within the dam plates. One of them is in fluid communication with a first connecting opening 214 provided at the top surface 205 of the dam plates, while the other is in fluid communication with a second connecting opening 216 provided at the top surface 205 of the dam plates. The inner fluid passage 210 is connected to the ink recovery tubings 22 and 24 via the first connecting opening 214, and it is also connected to the water supply tubings 62B and 62C via the second connecting opening 216. According to such constructions, a printing machine having an ink pan can be remodeled into that having a pair of dam plates, simply by connecting the ink delivery tubings and water supply tubing to the first connecting opening 214 and second connecting opening 216 of the dam plates 36 and 38, which allows easy fixing of the ink/water tubings as well as positioning of the flow in/out opening 204 near the bottom of the ink reservoir 16, whereby efficient remodeling can be achieved.

As can be seen in FIG. 1, the pair of squeezing blades 102A and 102B are formed in such a manner that when they are positioned in the ink reservoir 16 they constitute partitions or compartments of the ink reservoir 16 located in the axial direction of the ink reservoir 16; more particularly, they have plate-like shapes narrowly tapering toward its bottom having first curved side surfaces 101A and 101B and second curved side surfaces (not shown), in which first curved side surfaces 101A and 101B come into contact with the side surface of the inking roller 12, while second curved side surfaces come into contact with the side surface of the ink squeezing roller 14. The height of the respective blades 102A and 102B can be selected in such a manner that liquid being held between the dam plates 36 and 38 and the squeezing blades 102A and 102B will not cause an overflow when the squeezing blades 102A and 102B move toward axial ends of the roller, as will be described in detail below.

As can be seen in FIG. 4, the pair of squeezing blades 102A and 102B are attached to the respective supporting arms 104A and 104B, and these supporting arms are attached to the respective elevation mechanisms 106A and 106B. Both of the elevation mechanisms 106A and 106B move, via cylinders (not shown), elevator bases 108A and 108B on which supporting arms 104A and 104B are mounted, and by this movement, the pair of squeezing blades 102A and 102B can be moved reciprocally between their lower operating position for squeezing the ink or rinsing water within the ink reservoir 16 and their upper resting position spaced apart from the ink reservoir 16.

The elevation mechanisms 106A and 106B are provided on the moving mechanisms 111A and 110B, respectively, and the moving mechanisms 110A and 110B move the pair of squeezing blades 102A and 102B in the linear axial direction of the roller, via the elevation mechanisms 106A and 106B. More particularly, rotating shafts 116A and 116B engaging with the elevation mechanisms 106A and 106B and supported on machine frames 112A and 112B through bearings 114A and 114B are extended in the axial direction of the roller, and these rotating shafts 116A and 116B are connected to a motor 122 supported on machine frames 112A and 112B via the bracket 120. The rotating shafts 116A and 116B have oppositely directed threaded portions so as to correspond with the respective pair of squeezing blades 102A and 102B, and when the motor 122 rotates the rotating shafts 116A and 116B, the pair of squeezing blades 102A and 102B are moved in the opposite axial direction of the roller. More particularly, as can be seen in FIG. 4, the pair of squeezing blades 102A and 102B can reciprocally be moved in the axial direction between a first axial position in which they are positioned close to the opening end of the ink delivery tubing 20 and a second axial position in which they are positioned close to the axial ends of the roller which is a position very close to the inner surfaces of the dam plates 36 and 38.

The operation of the printing machine the construction of which has been discussed above will now be explained in detail below, which explanation includes respective stages of before, during and after printing.

The operations which have to be done before the printing operation is started are as follows. Various valves are operated before printing. More particularly, the open-close valve 54A is opened for suctioning the flexographic ink into the ink supply tubing 20. The open-close valve 82A is closed for preventing the flexographic ink flowing into the by-pass tubing 80A. The open-close valve 78A is closed for preventing the high pressure air from the high pressure air source 72 flowing into the air ejector 30A. Then, the air cylinder 96 of the transfer pump 26A is driven such that the support member 98 moves toward the rotor 94, thereby rotational pressure force by the rotor is applied against the outer surface of the ink supply tubing 20. The open-close valves 152, 154 and 68A are closed for preventing the water from the water supply tubing 28 flowing into the ink reservoir 16. At this time, the pair of squeezing blades 102A and 102B are positioned at their first axial position and their upper resting position.

Next, the operations during the printing operation will be described. The flexographic ink being kept in the ink supply source 18 is supplied to the ink reservoir 16 by driving the transfer pump 26A. At this time, by adjusting the rotation of the transfer pumps 26B and 26C, the ink recovery tubings are used as ink supply tubings, whereby three of ink transfer tubings are used to supply the flexographic ink from the ink supply source 18 to the ink reservoir 16. The flexographic ink supplied in the ink reservoir 16 is held therein without leaking out therefrom due to a pair of diaphragms or dam plates 36 and 38 disposed at the end extremities of the rollers 12 and 14. The flexographic ink being kept in the ink reservoir 16 is transferred or applied onto the outer surface of the inking roller 12 comprising a portion of the ink reservoir 16, and thereafter the ink is transferred or applied onto the printing die 42, whereby a corrugated board sheet S is printed.

During the printing operation discussed above, the amount of the flexographic ink being supplied via the ink supply tubing is more than that required for printing the corrugated board sheet S. Thus, excessive flexographic ink is recovered back to the ink supply source 18 via the ink recovery tubings 22 and 24 by driving the respective tubing pumps 26B and 26C through the inner fluid passage 210 of the pair of dam plates 36 and 38.

The flexographic ink having a quick-drying nature is effectively prevented from being solidified by providing a continuous movement of supplying and recovering thereof, i.e. by the circulation of the flexographic ink between the ink supply source 18 and the ink reservoir 16. Also, unevenness of the printing can be effectively prevented which might occur when the viscosity of the flexographic ink is distributed unevenly along the longitudinal direction of the ink reservoir 16 depending upon the positions of the ink supply tubing 20 and/or the ink recovery tubings 22 and 24. Moreover, the ink supply tubing 20 supported on the bracket 50 may be moved along the longitudinal direction of the ink reservoir 16 by the rotation of the threaded shaft 56 driven by the motor 58 in order to provide an active dynamic flow of the flexographic ink being kept in a particular place in the ink reservoir 16. The printing operation for one lot of corrugated board sheet has now been finished.

Next, the operations during the ink removing and/or recovering operation will be described. The flexographic ink still remaining in the ink reservoir 16 is recovered back to the ink supply source 18. More particularly, the remaining flexographic ink is recovered from the ink reservoir 16 to the ink supply source 18 via the inner fluid passage 210 and the ink recovery tubings 22 and 24 by the continuous driving movement of the tubing pumps 26B and 26C. Also, at the same time, the transfer pump 26A may be driven in the reverse direction in order to use the ink supply tubing 20 as one of ink recovery tubings for recovering the flexographic ink from the ink reservoir 16 to the ink supply source 18. According to such an embodiment, the time required for recovering the flexographic ink from the ink reservoir 16 can be further shortened.

When the recovering operation of the flexographic ink from the ink reservoir 16 to the ink supply source 18 is started, the pair of squeezing blades 102A and 102B are moved from their upper resting position to their lower operating position, so as to divide the ink reservoir 16 into three spaces, whereby remaining ink in those three spaces is respectively recovered to the ink supply source 18 through the ink supply tubing 20 and the ink recovery tubings 22 and 24. Then, the squeezing blades in the pair of squeezing blades 102A and 102B are moved into a second axial position by moving them in the axial opposite directions toward respective ends of the axis. Thus, the remaining ink adhering on the side surfaces of the inking roller 12 and the ink squeezing roller 14 can be squeezed out by the pair of squeezing blades 102A and 102B, which ink is directed into the remaining ink in the space of the ink reservoir formed between the pair of dam plates 36 and 38 and the pair of squeezing blades 102A and 102B, which raises the liquid level of the remaining ink in the ink reservoir, whereby allowing complete recovering of the remaining ink.

After the transfer pump 26A disposed on the ink supply tubing 20 has stopped, the supporting member 98 is moved apart from the rotor 94 by driving the air cylinder 96, whereby the ink supply tubing 20 is released from the pressure force applied by the rotor 94. At the same time, the valve 154 and the open-close valve 68A are opened.

Next, rinsing water is supplied from the water supply source 64 to the ink reservoir via the ink supply tubing 20. This rinsing water acts as supplement water. By this water, the inking roller 12, especially in the indentations of the inking roller 12, is kept in water-rich conditions, whereby allowing the good adhering condition of the ink during the printing operation in the next stage, and the wear at the rotational contacting portion between the inking roller 12 and the ink squeezing roller 14 is prevented. At this time, the recovery of the ink is continuing in the outer end spaces of the ink reservoir 16 partitioned by the squeezing blades 102A and 102B. Next, the open-close valves 78A, 78B and 78C are opened, whereby high pressure air from the high pressure air source 72 is supplied to the air ejector 30A connected to the ink supply tubing 20 and the air ejectors 30B and 30C connected to the ink recovery tubings 22 and 24, respectively. Air in the ink supply tubing 20 and the ink recovery tubings 22 and 24 flows at a high speed from the ink reservoir 16 to the air ejector 30A and to the air ejectors 30B and 30C, respectively, and thereafter flows toward the ink supply source 18, which allows recovery of the remaining ink from the ink supply tubing 20 and the ink recovery tubings 22 and 24 to the ink supply source 18.

When most of the flexographic ink within the ink reservoir 16 has been recovered, by opening the valve 152 and closing the valve 154, rinsing water is jetted out on the side surface of the roller from the water jet nozzle 160 of the water delivery tubing 158 with the rotation of the roller, whereby the flexographic ink adhering on the side surface of the roller can be rinsed out, and that rinsing water is recovered through the ink supply tubing and the ink recovery tubings. Then, the squeezing blades in the pair of squeezing blades 102A and 102B, having been located at the axial ends of the roller, are now returned to their first axial position and their upper resting position. Also, the pair of squeezing blades 102A and 102B may be returned during the rinsing operation of the water jet nozzle 160. Thereafter, as in the case of ink recovery, the rinsing water being held within the ink reservoir 16 is recovered via the three tubings 20, 22 and 24, and after most of the rinsing water within the ink reservoir 16 has been recovered, the pair of squeezing blades 102A and 102B is moved into their lower operating positions while moving toward corresponding axial ends, whereby remaining rinsing water can be recovered completely by using the ink delivery tubings 20 and 24 via flow in/out opening 204 through the inner fluid passage 210.

Then, the open-close valve 54A is closed, while the open-close valve 82A disposed in the by-pass tubing 80A is opened.

Next, the open-close valves 78A, 78B and 78C are opened, whereby high pressure air from the high pressure air source 72 is supplied to the air ejector 30A connected to the ink supply tubing 20 and the air ejectors 30B and 30C connected to the ink recovery tubings 22 and 24, respectively. Air in the ink supply tubing 20 and the ink recovery tubings 22 and 24 flows at a high speed from the ink reservoir 16 to the air ejector 30A and to the air ejectors 30B and 30C, respectively, and thereafter flows toward the ink supply source 18. On the other hand, almost at the same time that the high pressure air is supplied to the air ejectors 30A, 30B and 30C, water flowing from the water supply tubing 20 is supplied to the ink supply tubing 20 and the ink recovery tubings 22 and 24, respectively, via the valve 154 and the open-close valves 68A, 68B and 68C which are controlled at desired time intervals. By controlling the open-close valves 68A, 68B and 68C connected to the water supply tubing 20, the timing for water supplying can be adjusted in any desired way. The desired time intervals for supplying water can be selected depending upon various conditions, such as the amount of flexographic ink remaining in the ink supply tubing 20 and the ink recovery tubings 22 and 24, or flow speed of the air generated by the air ejectors 30A, 30B and 30C. Therefore, the flexographic ink remaining in the ink supply tubing 20 and the ink recovery tubings 22 and 24 can be prevented from being solidifies by supplying water therein, even when the moisture in the flexographic ink was evaporated by virtue of the high speed air flow. Thus, the flexographic ink remaining in the ink supply tubing 20 and the ink recovery tubings 22 and 24 can be effectively removed therefrom, which is recovered back to the ink supply source 18, and the inner surfaces of the ink supply tubing 20 and the ink recovery tubings 22 and 24 can be rinsed out.

When it is intended not only to remove or rinse out the flexographic ink remaining in the ink supply tubing 20 and the ink recovery tubings 22 and 24, but also intended to reuse the recovered flexographic ink, the amount of water being supplied can be adjusted depending upon the measurements of the water flow meters 66A, 66B and 66C, such that the ratio of supplied water to the recovered flexographic ink would not exceed a certain level. Preferably, the amount of water being supplied may be determined in relation to the viscosity of the ink being recovered, which is detected by the viscometer 52, since too much supplied water causes too low viscosity of the ink, which results in the deterioration of the printing quality. In another embodiment of the present invention, either of the water flow meters (66A, 66B and 66C) may be disposed downstream of the open-close valves (68A, 68B and 68C) to adjust the amount of water. Also, in another embodiment of the present invention, viscometers may be disposed in the path of the ink recovery tubings 22 and 24, as well.

The remaining flexographic ink left upon the surfaces of the inking roller 12 and the ink squeezing roller 14 is a small amount such as 50 grams in weight, so that it will be preferable to remove such ink by shaving it off with a scraper with the aid of a small amount of diluting agent. In this case, the ink removed by the scraper should not be recovered via the ink supply tubing 20 or the ink recovery tubings 22 and 24 for scrapping, in order to prevent the ink again adhered on the inner surfaces of the ink supply tubing 20 and the ink recovery tubings 22 and 24.

The operation for removing and/or recovering the flexographic ink remaining in the ink supply tubing and/or the ink recovery tubings, which can retain the recovered ink in the reusable form, has been finished. In accordance with the present invention, good adhering condition of the ink after a color change can be obtained.

Although the best modes contemplated by the inventor for carrying out the present invention have been shown and described herein, it will be apparent to those skilled in the art that suitable modifications, variations, and equivalents may be made without departing from the scope of the invention.

For example, although the preferred embodiment disclosed above utilizes the ink squeezing roller 14 which comes into contact with the inking roller in order to squeeze the ink, a doctor blade, for example, can be used in another embodiment of the present invention.

Also, in the preferred embodiment disclosed above, the ink reservoir 16 and the ink supply source 18 are connected to three of the ink delivery tubings; however, as long as the ink can be circulated during the printing operation, any modifications can be made. In such a modification having at least a ink supply tubing and ink recovery tubings, the ink supply tubing can be used for recovering the ink during ink recovering, whereas the ink recovery tubings can be used for supplying the ink during ink supplying.

What is claimed is:

1. A printing machine which includes an ink reservoir, an ink supply source, and one or more ink delivery tubings each connecting said ink reservoir to said ink supply source, whereby the ink supplied from said ink supply source via at least one of said ink delivery tubings to said ink reservoir and accumulated therein is used for printing, said ink delivery tubings including ink recovery tubings for recovering the flexographic ink from said ink reservoir to said ink supply source, said ink recovery tubings having their ink recovery opening ends located within said ink reservoir, said ink delivery tubings including an ink supply tubing for supplying the flexographic ink from said ink supply source to said ink reservoir, said ink supply tubing having its ink supply opening end located within said ink reservoir, whereby the ink within said ink reservoir is maintained in a dynamic state by supplying said flexographic ink from said ink supply source to said ink reservoir via said ink supply tubing and by recovering the flexographic ink from said ink reservoir to said ink supply source via said ink recovery tubings during the printing operation of the printing machine, wherein:
said ink recovery tubings and said ink supply tubing have ink transfer means which can transfer the ink in both forward and backward directions between said ink supply source and said ink reservoir,
wherein the flexographic ink is recovered from said ink reservoir to said ink supply source via said ink recovery tubings and said ink supply tubing now being used as an ink recovery tubing during ink recovering, and wherein the flexographic ink is supplied from said ink supply source to said ink reservoir via said ink supply tubing and said ink recovery tubings now being used as ink supply tubings during ink supplying.

2. The printing machine as recited in claim 1, wherein said ink reservoir is formed by an inking roller which applies said ink to a printing die, an ink squeezing member extending along the axis of said inking roller in contacting relationship with the same for the adjustment of the amount of said ink being applied to the printing die, and a pair of dam members disposed at common end extremities of said inking roller and said ink squeezing member,
said pair of dam members having ink flowing paths formed therein, respectively, said respective ink flowing paths having flowing in/out openings located at an inner surface of the said ink reservoir, said ink flowing path being in fluid communication with said ink delivery tubings.

3. The printing machine as recited in claims 1 or 2, further comprising:
a pair of squeezing blades located within said ink reservoir abut against the side surfaces of the said inking roller and said ink squeezing member;
a blade moving mechanism for moving the squeezing blades in said pair of squeezing blades in the opposite axial directions of said inking roller;
a supplement water supply source connected to said ink supply tubing; and
wherein said ink supply opening end is located between said pair of squeezing blades, whereby when the squeezing blades in said pair of squeezing blades are moved in the opposite directions toward the respective axial ends of the roller, supplement water from said supplement water supply source is supplied into said ink reservoir through said ink supply opening end in such a manner that the portion of said inking roller located between said pair of squeezing blades is supplied with water.
